(19) United States
(12) Patent Application Publication
(10) Pub. No.: US 2023/0089973 A1
(43) Pub. Date: Mar. 23, 2023

(54) DEFLECTOMETRY DEVICE FOR DIFFERENTIAL METROLOGY OF MATERIAL REMOVAL

(71) Applicant: QED TECHNOLOGIES INTERNATIONAL, INC., Aurora, IL (US)

(72) Inventors: Johnathan DAVIS, Honeoye Falls, NY (US); Christopher SUPRANOWITZ, Apex, NC (US); William MESSNER, Fairport, NY (US); Matthew SIDARE, Farmington, NY (US); Brian LACHANCE, Rochester, NY (US); Andrew JONES, Cincinnati, OH (US)

(21) Appl. No.: 17/946,927

(22) Filed: Sep. 16, 2022

Related U.S. Application Data
(60) Provisional application No. 63/245,887, filed on Sep. 19, 2021.

(51) Int. Cl. G01B 11/30; G01B 11/22; G03B 17/17; G03B 17/55; H04N 5/225

(52) U.S. Cl. CPC G01B 11/30; G01B 11/22; G03B 17/17; G03B 17/55; H04N 5/22521; H04N 5/22525

(57) ABSTRACT

A deflectometry device comprising a kinematic spot part holder, a display, an imaging optic, a stop, and a camera imaging assembly including a camera lens and a camera having a detector. Additionally is described, a deflectometry device that is part of a deterministic finishing machine comprising a display, an imaging optic, a stop, and a camera imaging assembly including a camera lens and a camera. Additionally, a method for characterizing material removal created by a deterministic finishing machine is provided.

### FIELD OF THE INVENTION

The present disclosure relates to systems, methods and apparatus that employ a deflectometry device designed to characterize, by way of differential metrology, material removal from a deterministic finishing machine, such as magnetorheological fluid (MRF) finishing spots.

### BACKGROUND

In the field of optical fabrication there are many reasons for measuring the topography of a surface. Perhaps the most common is quality assurance, specifically measuring the optic after each fabrication step, and evaluating whether the optic meets its required surface tolerances. For the case of optical fabrication, the present state of the optic must be known to determine if any further processing is necessary to achieve the desired shape, within the tolerances allowed, and whether any unexpected problems occurred during the fabrication step. For final optic qualification, the total measurement uncertainty must be significantly less than the optic tolerance to qualify that an optic is complete. One source of measurement uncertainty that can be mitigated is the systematic error of the instrument measuring the optic. Characterizing the systematic error can be performed a number of ways, one example being the measurement of a known calibration standard. Differences between the known shape and topography of the calibration standard and the measurement of the calibration standard performed with the instrument being calibrated can be used to estimate the instruments systematic error. Regardless of the tactics used to reduce various sources of uncertainty, the resultant absolute measurement accuracy is paramount for qualifying optical surfaces with tight tolerances.

Less common, is the need to know how an optics surface has changed between measurements. In this case, both the initial and subsequent measurements are needed to determine the surface change. The method used to estimate this change will be referred to as differential metrology, where what is being measured is the change of an optical surface from one measurement to another. An example of where differential metrology may be useful, is the measurement of an optic that is undergoing shape change due to some external influence, such as thermal or mechanical. See for example R. Briguglio, “Optical calibration and performance of the adaptive secondary mirror at the Magellan telescope”, Nature, Sci Rep 8, 10835 (2018) where calibration of an adaptive optic secondary requires initial and subsequent measurements to determine the influence of the actuators on the shape of the optic.

Another application for differential metrology, is the measurement of material removal created by some process. In this case an initial measurement is taken, followed by removal of material from the surface by some machine executed process, followed by a subsequent measurement. The change between the initial and subsequent measurement is used to estimate what material was removed, assuming that the measurement instrument has sufficient accuracy and capture range to do so. This information can be used in conjunction with the machines known parameters that were used during the removal process, to create what is commonly referred to as the machines tool influence function (TIF).

For this disclosure, the term deterministic finishing machine will be used to describe any machine that can predictably influence the surface of an optic, or substrate material, based on controlled parameters. To provide optimal convergence of an optic being processed the TIF of a deterministic machine must be accurately characterized. Magnetorheological finishing (MRF) machines are considered deterministic finishing machines, due to their ability to accurately correct errors in optical surfaces with nanometer precision. To accomplish this task, the MRF machine relies on an accurately characterized TIF. Other examples of deterministic finishing machines include ion beam figuring (IBF) and computer controlled sub-aperture polishing machines, both of which benefit from accurate characterization of the TIF to achieve optimal results.

For the remainder of this disclosure, the term “spot” will be used in a generic sense to specify the material removed by a deterministic finishing machine. The term “MRF spot” will be used to specify material removed by a MRF machine. The object and associated surface that the material removal will be generated on will be referred to as a “spot part” and “spot part surface” respectively. The action of removing material from the spot part, in the form of a spot, will be referred to as “spot taking”. The term “spot map” will be used to specify the measurement result created when differential metrology is used to estimate material removal generated during spot taking. Given these definitions, it is said that the spot map can be used in conjunction with the deterministic finishing machines known parameters that were used during the removal process, to characterize the machine TIF.

Most commercially available interferometers satisfy the metrological requirements of MRF spot taking in terms of nanometer sensitivity, spatial resolution, and slope capture range. However, they are not necessarily optimized in other aspects. The primary utility of an interferometer in the optics shop is to provide surface metrology of optics in process. The absolute measurement accuracy provided by the interferometer is critical to the optics successful completion. Therefore, interferometers are rigorously engineered to meet this absolute accuracy criteria. This engineering rigor, associated complexity, and the quality of the instrument components are correspondingly expensive. In the case of spot taking in conjunction with differential metrology, absolute measurement accuracy is less critical, as any reproducible systematic error present in the initial and subsequent measurements will be negated. In this way differential metrology is used to accurately isolate the change in the surface of the spot part, rather than the absolute shape. Steps to reduce measurement uncertainty sources such as systematic error are no longer necessary, assuming that the systematic error is reproducible between the measurements. Non-repeatability that occurs between measurements must also be minimized, systematic or not.

Another consideration is that most interferometers are sensitive to environmental conditions such as vibration and air turbulence, both of which can negatively impact the repeatability of the measurements. This environmentally induced non-repeatability can compromise the accuracy of the spot characterization process. Compounding this issue is the fact that MRF machines are often found in optical fabrication facilities that share space with other equipment such a conventional polishing machines and grinders. While these environmental conditions may be suitable for an MRF polishing machine, they are often not ideal for sensitive instruments such as interferometers. As a result, the metrology instrumentation that supports MRF spot taking is usually in a different location with better environmental controls or desensitized to the shop environment by way of expensive vibration isolation tables and/or an enclosure. Not all interferometers are influenced by the non-ideal conditions of the optical fabrication environment. Some interferometric instruments are less vibration sensitive and thus more suitable to measurements on the shop floor, but are more costly, complex, and/or may have reduced spatial resolution. An ideal solution for measuring MRF spots would be compatible with these environmental conditions while taking up minimal space, reducing the inefficiencies and higher cost associated with the interferometric solution.

U.S Pat. No. 9,068,904 demonstrates the design of several deflectometry systems that are surprisingly simple. This simplicity is a key driver in cost, rendering most deflectometry systems less expensive to build that an interferometer. In one of the proposed configurations, the deflectometry system consists of a CPU, display, optic under test, camera lens, and camera. In this example a known pattern is projected by a display, where it is then reflected by the test optic to the camera lens assembly. In this configuration slope information about the test optic can be learned by comparing the known projected pattern against what is imaged by the camera after the light from the display reflects off the test optic. While the simplicity of this design may be desirable, it is limited to the testing of concave optics, where the display and camera are approximately placed at the center of curvature of the optic under test. This limitation in the test geometry and spot part shape is not ideal for MRF spot taking, where spots are often taken on flat surfaces. Another challenge associated with this test configuration is that the geometry of the test must be known with great precision to achieve an accurate absolute measurement of the test optic. Failure to characterize the test geometry accurately can lead to systematic errors that compromise the absolute accuracy of the test.

In the paper “Deflectometry for measuring mount-induced mirror surface deformations” Proc. SPIE 10373, Applied Optical Metrology II, 103730I (23 Aug. 2017), E. Frater describes a deflectometry system that is used to measure mount induced surface deformations. This example shows the usefulness of a deflectometry system for differential metrology, where the systematic error of the test is managed by isolating changes from one measurement to another. While this system successfully manages systematic error, it is optimized for concave surfaces (like U.S. Pat. No. 9,068,904) limiting its usefulness for spot measurement. Testing flat and convex optics is discussed briefly, with the associated disadvantages of requiring a much larger display, radiometric inefficiencies, and additional measurement uncertainty. In addition, the optic under test is only deformed and therefore the alignment of the optic is undisturbed between measurements. For spot taking, the spot part must be removed from the measurement device between measurements. Therefore, precise re-alignment of the spot part is necessary between measurements to achieve good reproducibility of the systematic error between measurements, something that is not addressed with the design discussed above.

In the paper “Development of a portable deflectometry system for high spatial resolution surface measurements,” A. V. Maldonado, P. Su, and J. H. Burge, Appl. Opt., AO 53(18), 4023-4032 (2014), Maldonado presents a deflectometry system that utilized an “auxiliary” lens to relay light from a display to a test optic to a camera without the need for 1 to 1 center of curvature imaging geometry, and allowing for everything from convex, to plano, to concave optics to be tested. While providing certain advantages over use of center of curvature based systems (e.g., flexibility for measuring optics of different curvature; compact and lightweight design (less than 10 kg); excellent spatial resolution; excellent slope range; affordable to build, compared to interferometers), the deflectometry designs as described by Maldonado were still intended for absolute measurements of a surface. As such, the system still requires precise knowledge of the test geometry and employs several calibration process steps that are required to achieve nanometer level absolute measurement accuracy.

What is needed in the art, is a measurement device that is optimized, in terms of cost, vibration insensitivity, and ease of use, for the accurate measurement of a spot part surface, without complex calibrations that exist in the prior art.

### BRIEF SUMMARY

The present invention provides a deflectometry device comprising a kinematic spot part holder, a display, an imaging optic, a stop, and a camera imaging assembly including a camera lens and a camera; wherein the kinematic spot part holder is configured to hold and position a spot part surface to be measured; the imaging optic is designed based on the geometry of the spot part surface prescription; the display is positioned proximate the imaging optic which is positioned proximate the kinematic spot part holder, and the display and imaging optic are configured for directing the display light towards the spot part surface to be measured when a spot part surface is positioned in the kinematic spot part holder, and for redirecting reflected display light from the spot part surface back to the imaging optic where the light is then directed to the stop, the stop being positioned proximate the camera imaging assembly and geometrically controls the light reflected by the spot part surface that is admitted to the camera lens, the admitted light is then refracted by the camera lens and focused onto the camera detector; and a data analyzer which is capable of estimating the shape of the spot part surface.

The present invention further provides a method for characterizing material removal created by a deterministic finishing machine comprising (i) taking initial measurements of a spot part surface, (ii) removing material from the spot part surface with the deterministic finishing machine, (iii) taking subsequent measurements of the spot part surface after removing material, and (iv) determining depth and spatial qualities of the removed material based on the change between the initial measurements and the subsequent measurements; wherein the initial measurements and the subsequent measurements of the spot part surface are obtained with a deflectometry device, the deflectometry device comprising a display, an imaging optic, a stop, and a camera imaging assembly including a camera lens and a camera.

The present invention further describes a deflectometry device that is part of a deterministic finishing machine, comprising a display, an imaging optic, a stop, and a camera imaging assembly including a camera lens and a camera; wherein the imaging optic is designed based on the geometry of the test part surface prescription; the display and imaging optic are configured for directing the display light towards the test part surface when the test part is held by the deterministic finishing machine in the measurement position, and for redirecting reflected display light from the test part surface back to the imaging optic where the light is then directed to the stop; the stop being positioned proximate the camera imaging assembly, whereas the stop geometrically controls the light reflected by the test part surface that is admitted to the camera lens and focused onto the camera detector; and a data analyzer which is used to estimate the shape of the test part surface from the camera images; wherein the deterministic finishing machine has means for holding a spot part surface to be measured in an accurate position, which negates the need for a separate kinematic part holder.

### BRIEF DESCRIPTION OF THE SEVERAL VIEWS OF THE DRAWING(S)

FIG. 1 is a conceptual layout of the invention for measuring a plano surface

FIG. 2 is a conceptual layout of the invention for measuring a convex surface

FIG. 3 is a block diagram that demonstrates the method for creating a spot map, using existing best practices

FIG. 4a is an isometric view of the invention optimized for measuring MRF spots on plano surfaces

FIG. 4b is a plan view of the invention optimized for measuring MRF spots on plano surfaces

FIG. 5 is a functional block diagram of the software process to convert intensity images into a surface map for the present invention

FIG. 6 is a table of exemplary requirements for a deflectometry device optimized for measuring MRF spots

FIG. 7, comprising subfigures 7a-7b, shows isometric views of an embodiment of the part holder in the invention that employs kinematic nests to facilitate reproducible mounting of the part

### DETAILED DESCRIPTION

The present disclosure describes a new approach that fulfills requirements for accurately measuring spots, which is a critical component of accurately characterizing the TIF, without the need for expensive interferometry apparatus or complex test set ups.

In accordance with the present disclosure, it is proposed that differential metrology offers particularly enhanced value for aiding predictive and deterministic finishing processes, rather than in the final testing and qualification of optics. For use with deterministic finishing machines that rely on differential metrology for the machines to work optimally, the disclosed deflectometry device is found to hold unique value.

More particularly, the unique strengths of deflectometry and the requirements of spot taking in an optical fabrication environment complement each other. The present disclosure describes a deflectometry device for measuring the surface of a spot part before and after removal has taken place, facilitating accurate TIF characterization. Results are comparable to the current state of the art interferometer based systems (e.g., QED Technologies' QIS interferometer product), but with the following representative achievable improvements: significant reduction in build cost; size and weight reduction and thus improved portability; vibration insensitivity where the system can be used on an ordinary tabletop; increased slope capture range; increased spatial resolution.

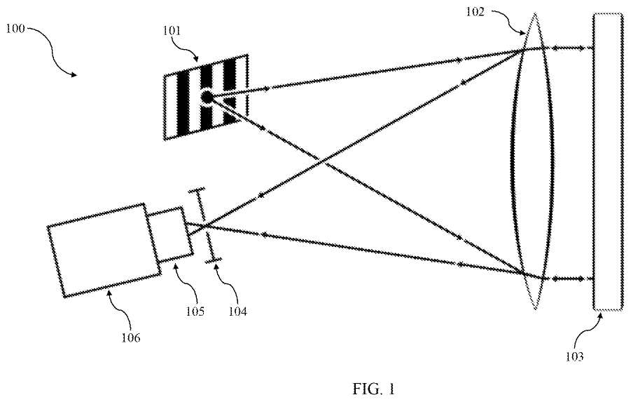

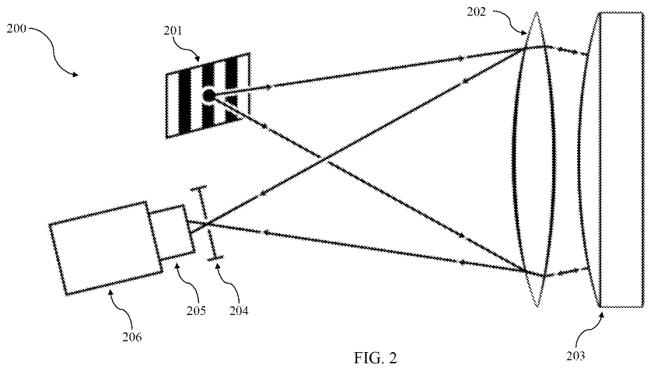

In the present disclosure, FIG. 1 demonstrates a general layout for a deflectometry system 100 used to measure a spot part surface. Light is emitted from the display 101 in the form of a known spatially varying intensity pattern, preferentially sinusoidal. The light travels toward imaging optic 102. For this embodiment, the light is approximately collimated by the imaging optic 102 which makes the light nominally normally incident on a plano spot part surface 103. The light is then reflected by the spot part surface 103, encoding any slope information present in the spot part surface by the law of reflection, where the angle of incidence is equal to the angle of reflection. The light is then redirected by the imaging optic toward the stop 104, where it is eventually focused onto the stop 104. Given this optical design the stop 104 is said to be conjugate to the display. The stop 104 geometrically controls what light can be admitted from the spot part surface reflection. The light admitted by the stop 104 is then refracted by camera lens 105, which is focused on the spot part surface 103. Finally, the light refracted by the camera lens 105 is incident on the detector of the camera 106.

The initial light pattern, which in this embodiment is a sinusoidal pattern in either X or Y direction, is phase shifted pursuant to the desired phase shifting algorithm. The light captured by the detector is turned into an intensity image which can then be interpreted by a digital analyzer such as a computer.

In another embodiment of the present invention, measuring non-plano spot part surfaces is possible. In FIG. 2 system 200 represents this modification of system 100, where the purpose of the imaging optic 202 is to refract the light from the display 201 so that it arrives approximately normal to the spot part surface 203, which in this case is convex. The light reflected by the spot part surface 203 is then re-directed by imaging optic 202, where it is then focused onto the stop 204. From this point forward the functionality of system 200 is equivalent to system 100. There are several ways to accomplish this alternate configuration, such as adjusting lens 202 spacing with respect to the display 201, the stop 204, and the spot part surface 203, and/or changing the optical design of the imaging optic 202.

It is evident to those skilled in the art that optical configurations other than a refractive design may be used for imaging optic 102 or 202. For example, in another embodiment a reflective mirror is used for the imaging optic. In this case, the mirror serves the same purpose of the refractive lens, which is to normalize the light coming from the display onto the surface of the spot part, followed by redirection of the display light back down to the displays conjugate, the stop. An off-axis parabola is preferred for a plano spot part surface, but other mirror configurations could be designed with good correction for the imaging conjugates considered. This approach provides another degree of design freedom, which may be advantageous given the many possible spot part surface shapes. One advantage of this design is the elimination of ghost reflections associated with the imaging lens design. For applications where elimination of ghost reflections is important, and/or where surface information in the center of the spot part is critical, a mirror design is ideal. However, the mirror design does have its disadvantages. To avoid obstruction of the light being emitted by the display towards the mirror, the spot part must be placed at a greater distance relative to the mirror than is needed in the refractive design of system 100. As such, the additional propagation distance from the spot part surface back to the mirror surface can lead to measurement uncertainty, loss of slope capture range, and vignetting, depending on the steepness of the slopes on the spot part surface.

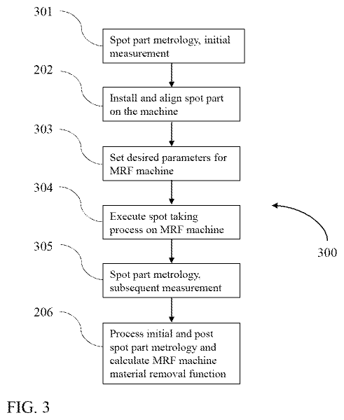

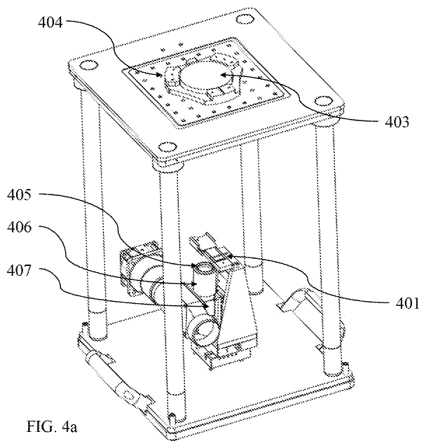

The deflectometry device described in FIG. 1 and FIG. 2 is used to acquire the necessary measurements for a spot map and thus an accurate TIF characterization. The process for creating a spot map using differential metrology, a deterministic machine, and a deflectometry device is shown in FIG. 3, in the form of a block diagram. In general, the spot part will be made of the same material type as the optic, or object, that will eventually polished. For example, if an optic being polished is N-BK7 glass, then the spot part will also be N-BK7. This method avoids the variations in removal rate that occur for substrate specific differences in hardness or other properties that would otherwise affect the removal rate mechanics of the finishing process. An initial spot part measurement is taken 301 by the deflectometry device to determine the shape of the spot part surface. The spot part is then installed and aligned 302 on the deterministic finishing machine, where it may be aligned and defined in the machine's software. Machine parameters that are known to affect the TIF are then set 303. These parameters may be optimized to achieve ideal TIF properties such as volumetric removal rate, peak removal rate, or general shape. The spot taking process is then executed 304 removing material from said spot part. The spot part is then measured again 305 by the same deflectometery device that was used in step 301. The differential metrology method then uses the initial spot part measurement result 306 and subsequent spot part measurement result 307 to calculate the material removal 308 generated in the spot part surface, producing a spot map 309. The spot map can then be used in conjunction with the known machine parameters, to calculate the TIF of the machine. Any errors in the calculated spot map can directly influence the accuracy of the TIF calculation. Failure to accurately characterize the TIF will affect the efficacy of the deterministic finishing process, and therefore must be minimized. For this reason, it is ideal to design the deflectometry device so that it is optimized for the type of removal it will be measuring. For an MRF machine these design optimizations may be different than those for a computer controlled sub-aperture polishing machine, or an IBF machine.

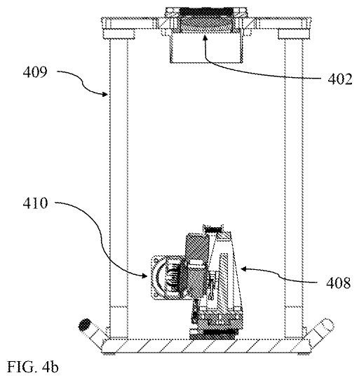

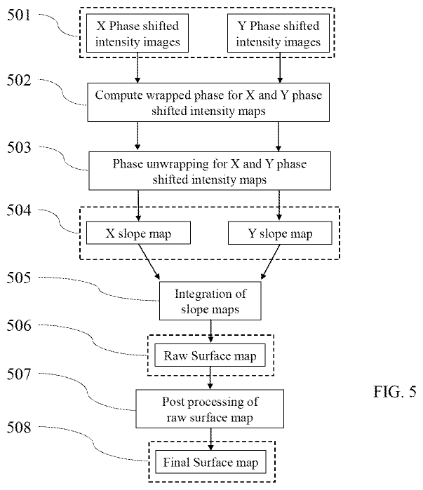

System 400 in FIG. 4a and FIG. 4b shows an embodiment of a deflectometry device optimized for measuring MRF spots comprising a computer (not shown) for software control, data collection and data processing; a display 401(preferentially a Micro-OLED, due to its superior intensity, contrast, and compactness properties when compared to displays used in the prior art) which projects the pattern generated by the computer software; the imaging optic 402 that roughly collimates the light from the display; a spot part 403, which is exchangeable, and is supported by a kinematic part holder 404 that ensures the alignment of the spot part surface is repeatable between measurements, an important aspect for minimizing systematic error non-reproducibility; a stop 405 that geometrically controls what light can be admitted from the spot part surface reflection; a camera lens 406, which focuses the light from the spot part surface onto the camera 407 having a detector, for example, a compact CMOS camera; pedestal 408, that supports the camera and display; metering rods 409 to rigidly control the positional relationship between the pedestal 408, and the imaging optic 402, where the rods are preferentially made of a low thermal expansion material such as carbon fiber to reduce susceptibility to thermal influences; a cooling system 410 (preferentially a thermo-electric cooler due to its compactness and ease of implementation) that regulates the camera temperature to minimize dark current for long exposure times.

Not shown in the diagram are the enclosure panels that are used to block stray light from infiltrating the system and affecting the quality of the measurements. An alternative solution is to increase the brightness of the display so that camera exposure times are sufficiently short. However, this mitigation strategy is practically limited by the available display technology; for example, while a micro-OLED display has programmable brightness, its lifetime is inversely correlated to the display brightness level, and thus shorter exposure times come at the expense of reduced device longevity.

A computer with suitable software is preferentially used for control of the device, data acquisition, and data processing which is performed by the software's data analyzer. The data acquisition process involves creating multiple pattern images based on the desired phase shifting method and then displaying them one by one on the display. After an image is displayed an intensity image is collected by the camera detector. The computer controlled display may be programmed to display images such as a sequence of sinusoidal patterns, with controllable frequency, with each image representing a π/2 radian phase shift, 4 each, for both the X and Y orientation. Each phase shifted image may be displayed for an appropriate length of time so that an image of the light pattern reflected by the spot part surface can be collected by the camera.

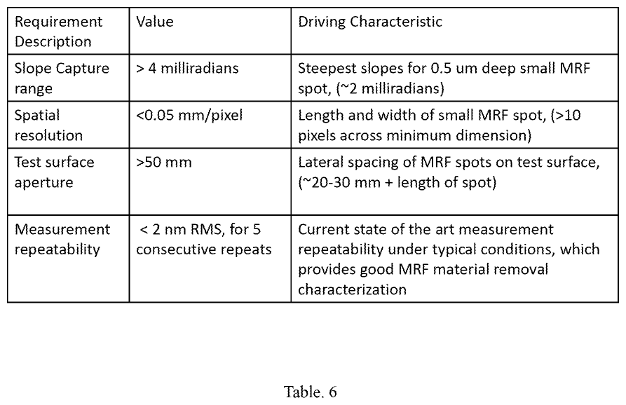

The sequence used by the software's data analyzer to process the acquired image files, to arrive at the desired spot map, is depicted in FIG. 5. First, the intensity images for each phase shift are collected 501. The total number of phase shifted images is dictated by the phase shifting algorithm, for example a 4-bucket phase shift algorithm would consist of 8 images, (4) X-phase shift images and (4) Y-phase shift images. The phase-shifted intensity images undergo wrapped phase map conversion 502, followed by phase unwrapping 503 to compute the X and Y slope maps 504.

For conversion of slope to surface height, given x and y slope maps (S^{x} and S^{y}, respectively), the samples of the surface height map φ are computed by integrating the slope maps 505, which is accomplished by solving a system of linear equations, as follows.

For each slope map sample at row i and column j, let

g_{i,j}^{L}=1 if S_{i,j-1}^{x},S_{i,j}^{x},S_{i,j-1}^{y}, and S_{i,j}^{y} exist, and 0 otherwise

g_{i,j}^{R}=1 if S_{i,j+1}^{x},S_{i,j}^{x},S_{i,j+1}^{y}, and S_{i,j}^{y} exist, and 0 otherwise

g_{i,j}^{U}=1 if S_{i-1,j}^{x},S_{i,j}^{x},S_{i-1,j}^{y}, and S_{i,j}^{y} exist, and 0 otherwise

g_{i,j}^{D}=1 if S_{i+1,j}^{x},S_{i,j}^{x},S_{i+1,j}^{y}, and S_{i,j}^{y} exist, and 0 otherwise

For each sample for which at least one of g_{i,j}^{L}, g_{i,j}^{R}, g_{i,j}^{U}, and g_{i,j}^{D} is nonzero, the following equation is added to the system:

φ_{i,j}(g_{i,j}^{L}+g_{i,j}^{R}+g_{i,j}^{U}+g_{i,j}^{D})−φ_{i,j-1}g_{i,j}^{L}−φ_{i,j+1}g_{i,j}^{R}−φ_{i-1,j}g_{i,j}^{U}−φ_{i+1,j}g_{i,j}^{D}=g_{i,j}^{L}(S_{i,j-1}^{x}+S_{i,j}^{x})/2−g_{i,j}^{R}(S_{i,j}^{x}+S_{i,j+1}^{x})/2−g_{i,j}^{U}(S_{i-1,j}^{y}+S_{i,j}^{y})/2+g_{i,j}^{D}(S_{i,j}^{y}+S_{i+1,j}^{y})/2

This system of equations is similar to those of the Southwell algorithm that is often used to compute phase from slope in Shack-Hartmann testing; see, for example, Section 10.4.3 in Optical Shop Testing, D. Malacara (ed.), 3^{rd} ed. (2007).

The system of equations is sparse (the number of equations is equal to the number of valid samples, while the number of nonzero coefficients in each equation is, at most, five). The solution may be computed using a Direct Sparse Solver in the Intel® Math Kernel Library, which is much more efficient than the Successive Over-relaxation (SOR) algorithm that is typically applied to slope-to-phase problems.

The resultant raw surface map 506 can then be post-processed 507 as desired for the intended application, for example scaling, masking, or filtering, whereby the final surface map 508 is created. Height scaling of the surface map, also referred to as Z-scaling, can be calibrated using the geometrical knowledge of the system or by way of a known calibration standard. Initial and subsequent final surface maps are used to calculate the spot map, by way of differential metrology, so that the MRF machine TIF can be calculated.

To take advantage of the strengths of deflectometry and overcome the sub-optimal qualities of interferometry for the application of measuring spots, design of the deflectometry system should be driven by the known characteristics of the spot. For MRF spots, particular attention is paid to assessing the slope capture range, spatial resolution, spot part surface aperture, and measurement repeatability. The smallest of MRF spots, roughly 1 mm wide by 2 mm long, drives the maximum slope capture range and spatial resolution requirements, while larger spots drive measurement repeatability and spot part surface aperture. Requirements may be re-optimized based on variables such as spot depth and spatial dimensions, both of which will vary across different processes and deterministic finishing machine types. These re-optimizations can be obtained by those skilled in the art within the confines of the invention described.

To illustrate the process of deriving requirements for a deflectometry device that is optimized for measuring MRF spots, FIG. 6 shows a table of first order optical requirements and their associated driving characteristic. The general design guidelines provided for this example are a preferred embodiment for designing a deflectometry device that is optimized for measuring spots made by an MRF machine.

The slope capture range is driven by the steepest slopes generated by the removal process. For example, a small 1 mm×2 mm MRF spot with a depth of 0.5 μm is not unreasonable given a soft material and aggressive polishing fluid. A spot of this depth can have slopes greater 2 milliradians. A slope capture range of at least twice this amount is a reasonable goal for the system to measure. An expression for estimating the slope capture range of a related deflectometry device, derived by Maldanado, is as follows:

$${θ}_{max} = 0.5 * \frac{( {D}_{s} - S )}{{EFL}_{C}} * 1000$$

Where θₘₐₓ is the slope range that can be measured, Dₛ is the size of the display in millimeters (assuming the minimum cross-section), and S is the stop diameter in millimeters. For system 400, the minimum cross-section of the display is the pixel pitch multiplied by the number of pixels. The stop size is selected based on the desired slope capture range, spatial resolution, and measurement repeatability. The effective focal length (EFL) of the imaging optic is based on a number of factors. For system 400 an imaging optic that collimates the light was selected so that plano spot part surfaces could be measured, where the display is approximately 1 focal length away from the imaging optic. To keep the system relatively compact, a short focal length was selected. For a configuration optimized for measuring plano parts the spatial resolution of the system is inversely proportional to the imaging optic focal length for a fixed spot part surface aperture. As such, the spatial resolution requirement must also be factored into the selection of the imaging optic. Furthermore, the slope sensitivity of the instrument is directly proportional to focal length, while the slope capture range is inversely proportional. This requires the instrument designer to strike a balance between the desired slope capture range, and slope sensitivity which is directly correlated to measurement repeatability. For spot part surfaces other than plano, where the imaging optic may not be collimating the light from the display, a different focal length, lens spacing, and optical design may be required for optimal performance. The relationship of imaging optic focal length to factors such as spatial resolution must be re-evaluated accordingly.

To achieve the desired spatial resolution several factors should be considered. A reasonable first step is to consider the spacing between the imaging optic and the display, and the diameter of the spot part surface aperture. This geometric relationship can be referred to as the F/# of the deflectometry device. For the system 400, the F/# is defined as the focal length of the collimator divided by the test aperture diameter. The camera lens and camera can then be selected to provide the desired spatial resolution, while considering the F/# of the deflectometry device. The spatial resolution is also influenced by the stop diameter, where reducing the stop size negatively impacts the diffraction-limited imaging performance of the camera and camera lens assembly. As previously mentioned, the stop diameter influences the slope capture range and measurement repeatability as well. Therefore, the stop diameter should be optimized considering all of the aforementioned associated requirements.

Measurement repeatability is a confluence of the theoretical design properties and many other factors as well. In terms of theoretical design, for system 400, measurement repeatability is directly related to the slope sensitivity of the system, which is proportional to display pixel pitch, and inversely proportional to the focal length of the imaging optic. This relationship encourages the designer to seek out a display with the highest resolution possible given the desired display form factor. The latest in Micro-OLED display technology provides a display that is very compact but has very high resolution, resulting in a very fine pixel pitch. These are ideal properties for a compact deflectometry device that needs to measure optical surfaces with nanometer sensitivity. An implementation of system 400 that employed a high-resolution Micro-OLED display (401 in FIG. 4a) produced measurement repeatability results that were less than 1 nm RMS for 5 consecutive measurements, which is comparable to the performance of interferometers routinely used for measuring material removal on spot part surfaces. In practice, other factors such as camera dark current play a critical role in measurement repeatability as well.

Testing with system 400 allowed for characterization of several factors influencing measurement repeatability. Camera dark current was found to be a very influential factor in measurement repeatability. This can be attributed to the radiometric properties of a system that requires exposure times that lead to an appreciable build-up of dark current. The relationship between camera exposure time and dark current is well documented, where longer exposure times can produce more dark current. For a deflectometry device, dark current can influence measurement repeatability by essentially raising the noise floor. A deflectometry device similar to system 400 but lacking cooler 410, was initially tested and found to produce measurement repeatability that was not adequate to meet the desired specification. This issue was attributed to the thermal properties of the camera. By adding a cooling system to the camera, measurement repeatability improved by an order of magnitude, allowing for sub-nanometer results.

Any suitable cooling means may be used, including passive cooling, thermal electric cooling, and even water cooling. Preferably, thermal electrical cooling is used due to the cooling performance it offers in a small package, low power consumption, and modest cost.

It is understood that some camera devices may exhibit lower dark current than others, and that electronics may vary in heat generation. Therefore, the best cooling method for any particular embodiment may vary. However, implementation of a cooling method allows for design flexibility when selecting a camera as well as other components to be used in the present invention.

Other factors such as stray light, display pattern generation performance, and software parameter selection were found to have an influence on measurement repeatability that was either obvious in nature or of minimal impact. Therefore, these influence factors are not discussed in more detail.

The measurement reproducibility of the system is another key factor that influences the deflectometry devices utility for measuring material removal on spot part surfaces. The process of creating a spot map, which is used for calculating the TIF of the deterministic finishing machine, generally requires that the spot part surface be removed from the measurement device, placed on the deterministic finishing machine where the removal process is conducted, followed by re-installation on the measurement device where the spot part surface is remeasured. Regardless of the process or the configuration, what is most important is the repeatable positioning of the spot part surface with respect to the deflectometer device.

In the current state of the art, where interferometers are employed for the measurement of material removal on spot part surfaces, the position of the spot part surface with respect to the instrument should generally be aligned to minimize tip/tilt/power. For a plano spot part surface, the cavity is ideally as small as possible to minimize environmental effects. Failure to achieve these alignments and optimizations can result in measurement non-reproducibility stemming from optical retrace, and environmental effects such as turbulence and vibration. In addition, the interferometer must also be focused on the spot part surface.

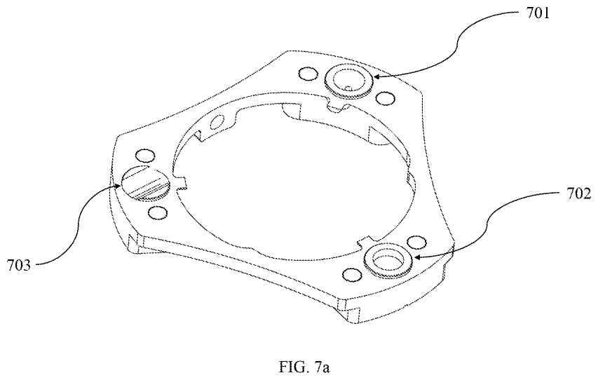

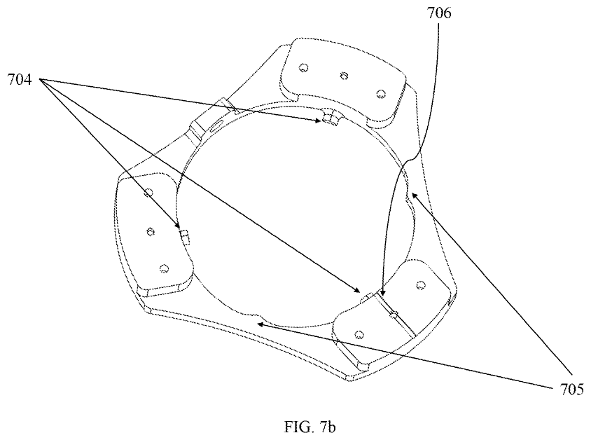

For the present invention knowledge of the test surfaces alignment with respect to the instrument is managed in a different way. The spot part is held by a kinematic part holder that allows for very repeatable placement of the spot part surface with respect to the deflectometry device. The kinematic part holder, shown in FIG. 7a and FIG. 7b, comprises a kinematic nest configuration that has been tested and confirmed to provide the necessary part positional repeatability. A total of 3 kinematic nests, consisting of a cone 701, flat 702 and V-groove 703, are placed at 120 deg with respect to each other, and at an equal radial distance. These nests register on 3 balls, with equivalent clocking and radial spacing to the nest geometry, that are located on top of deflectometry device near the collimator. This configuration controls 6 degrees of freedom, X, Y, Z, rotation about Z, and tip/tilt, for the kinematic part holder with respect to the deflectometry device. The part interface shown in FIG. 7b, which is where the part is installed, is on the opposite side of the kinematic mount and is designed for a cylinder shaped spot part with a plano surface, where the ratio of the diameter to the thickness is ideally 4:1 to 6:1(e.g 50 mm diameter part that is 12.5 mm thickness). The part interface consists of 3 axial contact points 704 that control the Z and tip/tilt position of the spot part surface, 2 radial contact points 705 that control the X and Y position of the part, and a clocking fiducial mark 706 used for rotationally orienting the part. A gravity or magnetic preload is used to ensure the kinematic nests and axial contact points are properly engaged. Force is applied (for example, by a spring-loaded set screw or flexure) to the outer diameter of the spot part opposite the radial contact points to ensure proper registration.

Without the kinematic part holder, non-repeatable positioning of the spot part surface, between the initial and subsequent spot part measurements, translates to non-reproducible systematic error between the measurements, which can lead to low order residual aberrations such as astigmatism and coma in the spot map. The kinematic part holder avoids these residual aberrations by accurately reproducing the optical geometry between the deflectometry device and the spot part surface from measurement to measurement, which in prior art was often managed with auxiliary measurements that added complexity and additional cost. In addition, no refocusing of the deflectometry device is required because longitudinal position of the spot part surface is repeatable.

In another embodiment of the invention, the deflectometry device can be used to measure a surface without the need for the differential metrology. In this instance the surface to be measured will be referred to as a “test part surface” and will be defined as any surface that is adequately reflective so that it can be measured with the deflectometry device and also within the slope capture range of the deflectometry device. To accurately measure the test part surface without differential metrology, the systematic error of the deflectometry device must be characterized. This can be accomplished by using the deflectometry device to measure a surface calibration standard of known shape, similar in shape to the test surface, which is then used to create a systematic error calibration map. The systematic error calibration map can be in either slope, or surface height form. Use of the systematic error calibration map can broaden the applicability of the deflectometry device for measuring test parts in applications other than spot taking, such as optics in the fabrication or qualification process. The kinematic part holder is a key component that enables this simple calibration method because the test geometry that was used to acquire the system calibration error map is reproduced for the measurement of the test part surface. The systematic error calibration error map can continue to be used across multiple test surface measurements, assuming that the systematic error of the deflectometry device is stable over time. The systematic error stability of system 400 was evaluated and found to drift less than 5 nm RMS over a 24 hour period. This systematic error drift can be considered part of the measurement uncertainty of the test part surface. In general, the more stable the systematic error is over time, the less often a calibration must be performed. Excellent stability of systematic error as a function of test part surface re-mount, and over time, makes the calibration process easy and infrequent. These qualities have been demonstrated on system 400.

Another embodiment is a deflectometry device integrated into the deterministic finishing machine. In this embodiment the function of the kinematic part holder, which is to repeatably position the spot part surface with respect to the deflectometry device, would be replaced by the machine's positional knowledge of the spot part surface with respect to the deflectometry device. Such a design would require that the machines positional accuracy is comparable to the positional repeatability of the kinematic spot part holder. This is not an unreasonable proposition, as many of today's deterministic finishing machines have micron level positional accuracy. The initial alignment steps required to determine the positional relationship of the spot part surface with respect to the deflectometry device are very similar to the current steps required to align and polish an optical surface on an MRF machine, or other deterministic finishing machine. Such a system would be ideal for situations where the spot taking and measurement process needs to be automated, which in turn would help to automate the deterministic finishing process of an optic in general.

Design of the imaging optic of the present invention can also influence measurement reproducibility, when factoring in spot part surface positional repeatability. The optical design should be optimized so that aberrations are minimized for the optical conjugates while also considering the devices slope capture range and display spectral properties. Optimization of these design criteria can be performed in a number of ways, one example being lens design software. One embodiment of system 400 used a singlet lens for imaging optic 402. It was found that the spherical aberration associated with this design made the deflectometry device more susceptible to spot part surface positional repeatability errors. To reduce this sensitivity, a preferred embodiment of the invention uses an achromatic doublet for imaging optic 402. The achromatic doublet has superior aberration correction for infinity conjugate imaging and the spectral properties of the preferred Micro-OLED display technology.

With the kinematic part holder 404 and achromatic doublet lens as imaging optic 402, the measurement reproducibility of system 400 was less than 5 nm RMS for 5 consecutive part surface remount measurements. The dominant errors, astigmatism, power and coma were of sufficiently low magnitude that their impact on the measurement of material removal and the associated TIF characterization is considered negligible.

Vibration susceptibility was compared for system 400 and a commercial interferometer commonly used for MRF spot measurements. In conditions where the interferometric system required a vibration isolation table to conduct MRF spot measurements, no such vibration isolation was necessary for the deflectometry device, to produce comparable measurement results.

Unique to the disclosed invention, is the combination of differential metrology for material removal characterization by a deterministic finishing machine and the highly repeatable and reproducible measurement properties of the deflectometry device. Characterizing the spot part surface accurately in an absolute sense is not necessary, provided the change in the spot part surface from the material removal process is accurately captured. For the example of MRF spot measurement, system 400 shown in FIG. 4a and FIG. 4b, produced results that were comparable to the prior art, making it a suitable alternative at reduced cost, complexity, and environmental sensitivity.

Multiple embodiments have been proposed to demonstrate the flexibility of the invention. As such it is understood that numerous changes are likely possible to derive new embodiments. Therefore, it is understood that the spirit and scope of the invention will be defined by the following claims, and not limited to the specific embodiments described herein:

1. A method for characterizing material removal created by a deterministic finishing machine comprising (i) taking initial measurements of a spot part surface, (ii) removing material from the spot part surface with the deterministic finishing machine, (iii) taking subsequent measurements of the spot part surface after removing material, and (iv) determining depth and spatial qualities of the removed material based on the change between the initial measurements and the subsequent measurements;
wherein the initial measurements and the subsequent measurements of the spot part surface are obtained with a deflectometry device, the deflectometry device comprising a display, an imaging optic, a kinematic part holder, a stop, and a camera imaging assembly including a camera lens and a camera.

2. The method of claim 1, wherein the steps of taking the initial measurements and the subsequent measurements of the spot part surface obtained with the deflectometry device include emitting light in the form of a spatially varying intensity pattern from the display that is refracted or reflected by the imaging optic, followed by reflection of the light off the spot part surface, followed by redirecting the reflected light back to the imaging optic, where the light is either reflected or refracted by the imaging optic, followed by forming an image of the light from the display at the stop which geometrically controls the light admitted to the camera lens that was reflected by the spot part surface, followed by refracting the admitted light by the camera lens on to the camera detector where it is focused; and wherein the display and camera are synchronized so that programmed changes in the intensity variation are simultaneously captured by the camera, and acquired images then undergo data analysis by a data analyzer to reconstruct a topographical map of the test surface for each of the initial and subsequent measurements.

3. The method of claim 1, wherein step (iv) determining depth and spatial qualities of the removed material based on the change between the initial measurements and the subsequent measurements includes determining changes in the surface topography of the spot part surface between the initial measurements and the subsequent measurements, by way of differential metrology, to produce a spot map.

4. The method of claim 1, wherein the deterministic finishing machine comprises an MRF machine.

5. The method of claim 1, wherein the display comprises a micro-OLED display.

6. The method of claim 1, wherein the imaging optic comprises an imaging lens which is optimized for a plano spot part surface.

7. The method of claim 1, wherein the imaging optic comprises an achromatic doublet collimating lens.

8. The method of claim 1, wherein the imaging optic comprises an imaging lens which is optimized for a non-plano spot part surface.

9. The method of claim 1, wherein the imaging optic comprises an imaging mirror which is optimized for measuring a plano spot part surface.

10. The method of claim 1, wherein the imaging optic comprises an imaging mirror which is optimized for a non-plano spot part surface.

11. The method of claim 1, wherein the steps of taking the initial measurements and the subsequent measurements of the spot part surface obtained with the deflectometry device further include actively controlling the temperature of the camera.

12. The method of claim 11, wherein the step of actively controlling the temperature of the camera includes cooling the camera of the camera imaging assembly.

13. A deflectometry device comprising a kinematic spot part holder, a display, an imaging optic, a stop, and a camera imaging assembly including a camera lens and a camera having a detector; wherein
the kinematic spot part holder is configured to hold and position a spot part surface to be measured;
the imaging optic is designed based on the geometry of the spot part surface prescription;
the display is positioned proximate the imaging optic which is positioned proximate the kinematic spot part holder, and the display and imaging optic are configured for directing the display light towards the spot part surface to be measured when a spot part surface is positioned in the kinematic spot part holder, and for redirecting reflected display light from the spot part surface back to the imaging optic where the light is then directed to the stop;
the stop is positioned proximate the camera imaging assembly and geometrically controls the light reflected by the spot part surface that is admitted to the camera lens, the admitted light is then refracted by the camera lens and focused onto the camera detector; and
a data analyzer which is capable of estimating the shape of the spot part surface.

14. The device of claim 13, wherein the imaging optic comprises an imaging lens which is optimized for a plano spot part surface.

15. The device of claim 13, wherein the imaging optic comprises an achromatic doublet collimating lens.

16. The device of claim 13, wherein the imaging optic comprises an imaging lens which is optimized for a non-plano spot part surface.

17. The device of claim 13, wherein the imaging optic comprises an imaging mirror which is optimized for measuring a plano spot part surface.

18. The device of claim 13, wherein the imaging optic comprises an imaging mirror which is optimized for a non-plano spot part surface.

19. The device of claim 13, further comprising means for controlling the temperature of the camera.

20. The device of claim 13, wherein the device is used with a deterministic finishing machine.

21. The device of claim 20, wherein the deterministic finishing device comprises an MRF machine.

22. A deflectometry device that is part of a deterministic finishing machine comprising a display, an imaging optic, a stop, and a camera imaging assembly including a camera lens and a camera; wherein
the imaging optic is designed based on the geometry of the test part surface prescription;
the display is positioned proximate the imaging optic which is positioned proximate the test part surface, which is held by the deterministic finishing machine during the test part surface measurement, and the display and imaging optic are configured for directing the display light towards the test part surface when the test part is held by the deterministic finishing machine in the measurement position, and for redirecting reflected display light from the test part surface back to the imaging optic where the light is then directed to the stop;
the stop is positioned proximate the camera imaging assembly and geometrically controls the light reflected by the test part surface that is admitted to the camera lens, the admitted light is then refracted by the camera lens and focused onto the camera detector; and
a data analyzer which is used to estimate the shape of the test part surface from the camera images; the deterministic finishing machine has means for holding a spot part surface to be measured in an accurate position, which negates the need for a separate kinematic part holder.

23. The device of claim 22, wherein the device is used to assess material removal generated by a MRF machine.

24. The device of claim 22, wherein the display comprises a micro-OLED display.

25. The device of claim 22, wherein the imaging optic comprises an imaging lens which is optimized for a plano test part surface.

26. The device of claim 22, wherein the imaging optic comprises an achromatic doublet collimating lens.

27. The device of claim 22, wherein the imaging optic comprises an imaging lens which is optimized for a non-plano test part surface.

28. The device of claim 22, wherein the imaging optic comprises an imaging mirror which is optimized for measuring a plano test part surface.

29. The device of claim 22, wherein the imaging optic comprises an imaging mirror which is optimized for a non-plano test part surface.

30. The device of claim 22, further comprising means to control the temperature of the camera.
